(19) United States
(12) Patent Application Publication
(10) Pub. No.: US 2025/0269582 A1
(43) Pub. Date: Aug. 28, 2025

(54) PREPARATION METHOD OF PET ENVIRONMENTAL PROTECTION FLOORING AND PET ENVIRONMENTAL PROTECTION FLOORING THEREOF

(71) Applicant: Zhongshan Nature Green New Materials Co., Ltd., Zhongshan (CN)

(72) Inventors: Sheng CHEN, Zhongshan (CN); Chaogang WANG, Zhongshan (CN); Tingmeng SU, Zhongshan (CN)

(73) Assignee: Zhongshan Nature Green New Materials Co., Ltd., Zhongshan (CN)

(21) Appl. No.: 19/208,542

(22) Filed: May 14, 2025

(30) Foreign Application Priority Data
Nov. 18, 2024 (CN) 202411644286.7

(51) Int. Cl. B29C 63/02; B29C 59/02; B29K 67/00; B29L 7/00; E04B 5/43

(52) U.S. Cl. CPC B29C 63/025; B29C 59/026; E04B 5/43; B29K 2067/003; B29L 2007/002

(57) ABSTRACT

The present invention provides a preparation method of PET environmental protection flooring, which facilitates preliminary mixing and plasticization of raw materials while preventing over-plasticization through coordinating a high-speed mixer and a low-speed mixer, thereby ensuring uniform mixing of the raw materials. Besides, a roller press is used to pr-bond a wear-resistant layer and a decorative film layer while base patterns are is embossed on a substrate layer, thus to achieve rapid molding, bonding, and surface pattern decoration of the three layers, thereby improving production efficiency. The present invention further provides a PET environmental protection flooring, which replaces traditional PVC materials with polyethylene terephthalate for reducing potential risks to human health and the environment. Through the design of multi-layer structure, the wear resistance, decorativeness and structural stability of the floor can be enhanced, thus to prolong the service life of the flooring.

### RELATED APPLICATIONS

The present patent document claims the benefit of priority to patent application No. 202411644286.7, filed Nov. 18, 2024, and entitled “PREPARATION METHOD OF PET ENVIRONMENTAL PROTECTION FLOORING AND PET ENVIRONMENTAL PROTECTION FLOORING THEREOF,” the entire contents of each of which are incorporated herein by reference.

### BACKGROUND

### 1. Technical Field

The present invention belongs to the technical field of polymeric materials, and particularly relates to a preparation method of PET environmental protection flooring and a PET environmental protection flooring thereof.

### 2. Background Information

As a type of flooring decoration material, PVC floors are primarily composed of polyvinyl chloride (PVC) and copolymer resins, and produced by adding fillers, plasticizers, stabilizers, colorants and other auxiliary materials onto a sheet continuous substrate through coating, calendering, extrusion or pressing processes.

However, some additives (such as plasticizers, stabilizers and etc.) used in the production process of the PVC floors, may cause potential risks to human health and the environment. For instance, some of the plasticizers may release harmful substances that affect indoor air quality; while some of the stabilizers may cause pollution to soils and water. Secondly, under high temperature environments, the PVC floors may release harmful substances, and abrasion, aging, or improper treatments during use can also release harmful substances, which pose potential risks to human health and the environment.

Additionally, preparation processes of traditional floors also have problems of uneven mixing of substrate raw materials, poor stability during plasticization process, insufficient interfacial strength between layers, and etc.

### BRIEF SUMMARY

The purpose of the present invention is to provide a preparation method of PET environmental protection flooring to solve the problems of uneven mixing of the substrate raw materials, poor stability during plasticization process, and insufficient interfacial strength between layers in the preparation processes of traditional floors.

The present invention is realized by the following technical solutions.

A preparation method of PET environmental protection flooring comprises the following steps:
S1. Preparing for substrate: according to a preparation ratio, feeding substrate raw materials into a high-speed mixer for heating and stirring, then a low-speed mixer for cooling down and stirring, and then melting the substrate raw material after being cooled down through an extruder until the substrate raw material reaches a uniformly plasticized state to obtain a plasticized substrate;
S2. Substrate forming: transporting the plasticized substrate obtained in step S1 from the extruder to a mold runner distributor, and then extruding it through the mold runner distributor to form a substrate structure to obtain a substrate layer;
S3. Pre-bonding: bonding a decorative layer and a wear-resistant layer in sequence on a surface of the substrate layer through a servo film feeding roller and a roller press, and embossing base textures on a lower surface of the substrate layer through the roller press to obtain a semi-finished product; and
S4. Floor forming: embossing surface textures on a surface of the wear-resistant layer of the semi-finished product obtained in step S3 through the roller press to obtain a PET environmental protection flooring.

Specifically, as shown in FIG. 1, the pre-bonding process in S3 is as follows: wherein the substrate layer extruded from the extrusion die 20 is transported to thickness fixing rollers 16 and 17 for thickness fixing, then the substrate layer is transported to a pre-bonding roller 14 for pre-bonding to the decorative layer and then is transported to the film pressing roller (rubber roller) 13 to bond the wear-resistant layer with the decorative layer; at the same time, base patterns are embossed on a lower surface of the wear-resistant layer through a pattern roller 15; finally, the semi-finished product is transported between the rubber roller 19 and the embossing roller 18, and surface patterns are embossed on a surface of the wear-resistant layer through the embossing roller 18 to obtain a PET environmental protection flooring.

The decorative layer is transported from color film roller supports 5 and 6 to the pre-bonding roller 14 through flattening rollers 7, 8 and 9, for pre-bonding with the substrate layer. The wear-resistant layer is transported from wear-resistant roller supports 1 and 2 to the film press roller 13 through flattening rollers 3, 4 and 10, a preheating roller 11, and a film-pressing roller 12, for tightly bonding with the decorative layer and the substrate layer.

Preferably, a stirring speed of the high-speed mixer in S1 is 50-120 kg/min, and a stirring temperature is 115-125° C. A stirring speed of the low-speed mixer is 200-300 kg/min, and a stirring temperature is 45-55° C.

In this method, the high-speed mixer is used for heating and stirring. By optimizing the stirring speed and temperature, the substrate raw materials can be effectively mixed and uniformly dispersed, and part of the raw materials can be promoted to enter the pre-plasticization stage. However, if the stirring speed is not adjusted at this stage, the plasticization of the raw materials may be accelerated, resulting in over-plasticization. Therefore, in this method, the low-speed mixer is used for cooling down and stirring, so as to slow down the over-plasticization of the raw material, ensuring that the substrate raw materials reach an appropriate plasticized state before entering the extruder. In addition, the efficiency of the high-speed mixer is much higher than that of the extruder, if the stirring speed is not adjusted, a large amount of the raw materials will quickly flow into the screws and molds of the extruder, which is easy to cause equipment failures such as screw locking and mold plugging. By optimizing the stirring speed and temperature, thorough mixing, pre-plasticization and stable plasticization of the substrate raw materials can be fully achieved, and the production efficiency and safety are enhanced at the same time.

The present invention further provides a PET environmental protection flooring to solve the problem that the existing PVC floor material has potential hazard risks in the process of production and use.

A PET environmental protection flooring is prepared by the preparation method of PET environmental protection flooring. The PET environmental protection flooring comprises a wear-resistant layer, a decorative film layer, and a substrate layer that are arranged in sequence.

The wear-resistant layer includes the following components:
80-90 parts by weight of Polyethylene terephthalate,
10-15 parts by weight of antioxidant,
0.1-0.5 parts by weight of ultraviolet absorber, and
0.1-0.5 parts by weight of colorant.

The antioxidant is a bis(2,4-di-tert-butylphenyl) pentaerythritol diphosphate.

The decorative film layer includes the following components:
90 parts by weight of Poly (1,4-cyclohexanedimethylene terephthalate-co-ethylene terephthalate),
3 parts by weight of titanium dioxide,
6 parts by weight of pigment, and
1 part by weight of solvent.

The substrate layer includes the following components:
70-90 parts by weight of Polyethylene terephthalate,
250-300 parts by weight of filler,
10-15 parts by weight of toughening agent,
10-15 parts by weight of lubricant, and
0.5 parts by weight of coloring agent.

The filler is a calcium carbonate, the toughening agent is an ethylene methacrylic acid copolymer, the lubricant is a Pentaerythrityl tetrastearate, and the colorant is a carbon black or titanium dioxide.

The substrate layer uses the polyethylene terephthalate (PET) as a main component. The PET is an environmental protection thermoplastic polyester material with high strength and rigidity, excellent transparency and luster, as well as outstanding chemical resistance and heat resistance. It contains no harmful chlorine elements, releases no hazardous substances during use, and does not deform or produce toxic gases when exposed to heat. Secondly, the ethylene-methacrylic acid copolymer is used as the toughening agent, so the impact strength and low temperature toughness of the floor are improved. The pentaerythritol stearate is used as the lubricant, the fluidity of the material during the preparation process is improved, so that the production efficiency and product quality are improved. The calcium carbonate is used as the filler, the dimensional stability of the floor is improved and the heat resistance is enhanced. In addition, more preferably, the calcium carbonate is a heavy calcium carbonate with high-purity limestone. Compared with the light calcium carbonate, the high-purity limestone has higher density and lower deposition volume, which can increase the volume of the product, thereby saving costs.

Additionally, the wear-resistant layer uses bis(2,4-di-tert-butylphenyl) pentaerythritol diphosphate as an antioxidant, which can enhance thermal stability of the polymer, effectively prevent oxidative degradation of the polymer during processing and use, and prolong the service life of the materials.

The present invention replaces the traditional PVC material with the Polyethylene terephthalate (PET) to reduce potential risks to human health and the environment. Secondly, similar components are used in the wear-resistant layer, the decorative film layer and the substrate layer, so that the three layers can be closely bonded by means of “like dissolves like” during the rolling process without using additional adhesives, thereby improving production efficiency and reducing production costs. Finally, through the cooperation of other additives and the design of multi-layer structure, the wear resistance, decorativeness and structural stability of the floor can be enhanced, and the service life of the floor can be prolonged.

Preferably, the PET environmental protection flooring further comprises a UV layer arranged on a side of the wear-resistant layer.

The UV layer includes the following components:
20-30 parts by weight of acrylate resin,
3-5 parts by weight of photoinitiator, and
5-10 parts by weight of filler.

The acrylate resin is one or more combinations of polyurethane acrylate, 1,6-hexanediol diacrylate, silicone acrylate resin, and trimethylolpropane triacrylate,

The photoinitiator is a hydroxycyclohexyl phenyl ketone.

The filler is one or more combinations of ceramic powder, silicon dioxide, and silica micropowder.

Preferably, the UV layer has a thickness of 0.01-0.03 mm, the wear-resistant layer has a thickness of 0.07-1.0 mm, the decorative film layer has a thickness of 0.07-0.12 mm, and the substrate layer has a thickness of 1-9 mm.

Preferably, the PET environmental protection flooring further includes a back cushion layer provided on a side of the substrate layer, and the back cushion layer has a thickness of 0.8-3 mm.

A material of the cushion layer can be CORK, IXPE, and EVA, and can be connected to the substrate layer by using environmental protection hot-melt adhesives or component adhesives.

Preferably, the PET environmental protection flooring has a density of 1.9-2.1 g/cm³, and the PET environmental protection flooring has a heating size change rate of ≤0.11%.

The heating size change rate is a direct indicator for evaluating the stability of the floors. A lower heating size change rate means less expansion or contraction of the floor under high temperatures, so that locking system stability of the floor is better, and installation and use is more reliable.

The present invention has the following beneficial effects.

The present invention provides a preparation method for the PET environmental protection flooring. Firstly, a high-speed mixer is used for heating and stirring to facilitate preliminary mixing and plasticization of the raw materials, and then a low-speed mixer is used for cooling down and stirring to prevent over-plasticization of the raw materials and ensure uniform mixing of the raw materials. Through the cooperation of high-speed mixer and low-speed mixer, the plasticization effect of the raw materials can be better achieved, so as to prevent the over-plasticization of the raw materials and avoid damages to equipment at the same time. Secondly, through the design of the roller press, the wear-resistant layer and the decorative film layer are pre-bonded while base patterns are embossed on the substrate layer, thus to achieve rapid molding, bonding, and surface pattern decoration of the three layers, hereby improving production efficiency. Besides, the problems of uneven mixing of the raw materials, poor stability during plasticization process, and insufficient interfacial strength between layers in preparation processes of traditional floors are solved.

The present invention further provides a PET environmental protection flooring. Firstly, by replacing traditional PVC material with Polyethylene terephthalate (PET), a more environmental protection and harmless material is provided to reduce potential risks to human health and the environment. Secondly, similar components are used in the wear-resistant layer, the decorative film layer and the substrate layer, so that the three layers can be closely bonded by means of “like dissolves like” during the rolling process without using additional adhesives, thereby improving production efficiency and reducing production costs. Finally, through the cooperation of other additives and the design of multi-layer structure, the wear resistance, decorativeness and structural stability of the floor can be enhanced, and the service life of the floor can be prolonged. The present invention effectively solves the problem that the existing PVC floor materials have potential hazard risks in the process of production and use.

### BRIEF DESCRIPTION OF THE DRAWINGS

FIG. 1 is a schematic structure view of a PET environmental protection flooring according to the present invention.

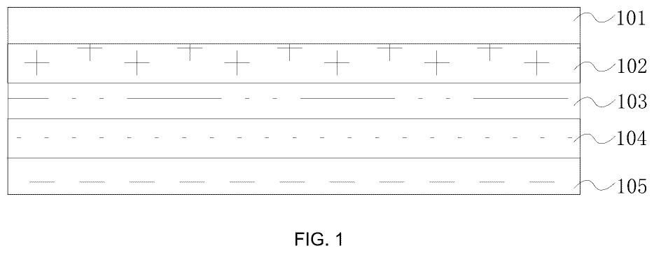

FIG. 2 is a flow chart of a preparation method of PET environmental protection flooring according to the present invention.

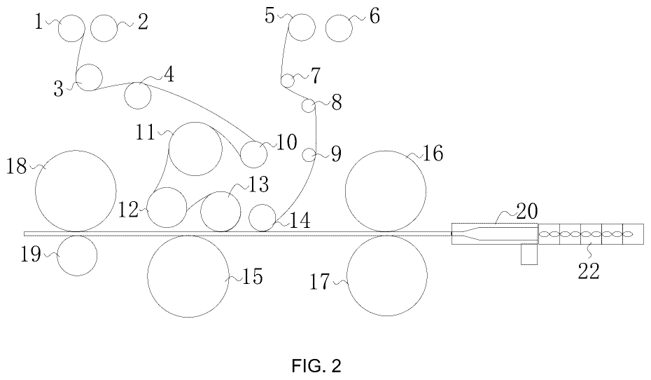

Reference numbers in the drawing: UV layer 101; wear-resistant layer 102; decorative layer 103; substrate layer 104; back cushion layer 105; wear-resistant roller supports 1, 2; flattening rollers 3, 4, 7, 8, 9, 10; color film roller supports 5, 6; pre-heating roller 11; film press rollers 12, 13; pre-bonding roller 14; pattern roller 15; thickness fixing roller 16, 17; embossing roller 18; rubber roller 19; extrusion die 20; screw 22.

### DETAILED DESCRIPTION OF THE DRAWINGS AND THE PRESENTLY PREFERRED EMBODIMENTS

The specific technical solutions of the present invention are described below in conjunction with Embodiments 1-3. It should be understood that the specific embodiments described herein are only used to explain the present invention and are not intended to limit the invention.

### Embodiment 1

A preparation method of PET environmental protection flooring comprises the following steps:
S1: Preparing for substrate: according to Table 1, feeding substrate raw materials into a high-speed mixer for heating and stirring for 6 minutes at a stirring speed of 50 kg/min and a stirring temperature of 115° C., then a low-speed mixer for cooling down and stirring for 18 minutes at a stirring speed of 220 kg/min and a stirring temperature of 46° C., and then melting the substrate raw material after being cooled down through an extruder until the substrate raw materials reach an uniformly plasticized state to obtain a plasticized substrate;
S2: Substrate forming: transporting the plasticized substrate obtained in step S1 from the extruder to a mold runner distributor, and then extruding it through the mold runner distributor to form a substrate structure to obtain a substrate layer 104;
S3: Pre-bonding: bonding a decorative layer 103 and a wear-resistant layer 102 in sequence on a surface of the substrate layer 104 through a servo film feeding roller and a roller press, and embossing base textures on a lower surface of the substrate layer 104 through the roller press to obtain a semi-finished product; and
S4: Floor forming: embossing surface textures on a surface of the wear-resistant layer 102 of the semi-finished product obtain in step S3 through the roller press to obtain an PET environmental protection flooring.

### Embodiment 2

A preparation method of PET environmental protection flooring comprises the following steps:
S1. Preparing for substrate: according to Table 1, feeding substrate raw materials into a high-speed mixer for heating and stirring for 6 minutes at a stirring speed of 50 kg/min and a stirring temperature of 118° C., then a low-speed mixer for cooling down and stirring for 15 minutes at a stirring speed of 220 kg/min and a stirring temperature of 45° C., and then melting the substrate raw material after being cooled down through an extruder until the substrate raw materials reach an uniformly plasticized state to obtain a plasticized substrate;
S2. Substrate forming: transporting the plasticized substrate obtained in step S1 from the extruder to a mold runner distributor, and then extruding it through the mold runner distributor to form a substrate structure to obtain a substrate layer 102;
S3. Pre-bonding: Pre-bonding: bonding a decorative layer 103 and a wear-resistant layer 102 in sequence on a surface of the substrate layer 104 through a servo film feeding roller and a roller press, and embossing base textures on a lower surface of the substrate layer 104 through the roller press to obtain a semi-finished product; and
S4. Floor forming: embossing surface textures on a surface of the wear-resistant layer 102 of the semi-finished product obtained in step S3 through the roller press to obtain a PET environmental protection flooring.

### Embodiment 3

A preparation method of PET environmental protection flooring comprises the following steps:
S1. Preparing for substrate: according to Table 1, feeding substrate raw materials into a high-speed mixer for heating and stirring for 6 minutes at a stirring speed of 60 kg/min and a stirring temperature of 120° C., then a low-speed mixer for cooling down and stirring for 20 minutes at a stirring speed of 220 kg/min and a stirring temperature of 50° C., and then melting the substrate raw material after being cooled down through an extruder until the substrate raw materials reach an uniformly plasticized state to obtain a plasticized substrate;
S2. Substrate forming: transporting the plasticized substrate obtained in Step S1 from the extruder to a mold runner distributor, and then extruding it through the mold runner distributor to form a substrate structure to obtain a substrate layer 104;
S3. Pre-bonding: bonding a decorative layer 103 and a wear-resistant layer 102 in sequence on a surface of the substrate layer 103 through a servo film feeding roller and a roller press, and embossing base textures on a lower surface of the substrate layer 104 through the roller press to obtain a semi-finished product; and
S4. Floor forming: embossing surface textures on a surface of the wear-resistant layer 102 of the semi-finished product obtained in step S3 through the roller press to obtain an PET environmental protection flooring.

The PET environmental protection flooring obtained from Embodiments 1-3 is directly coated with a UV layer 101 on a surface of the wear-resistant layer 102 of the PET environmental protection flooring through a paint line, and then a back cushion layer 105 is attached to a bottom layer of the substrate layer 104 by using an environmental protection hot melt adhesive, thus to obtain a PET environmental protection flooring product.

### Comparative Example 1

A preparation method of PET environmental protection flooring comprises the following steps:
S1. Preparing for substrate: according to Table 1, feeding substrate raw materials into a high-speed mixer for heating and stirring for 6 minutes at a stirring speed of 50 kg/min and a stirring temperature of 122° C., and then melting the substrate raw material after being cooled down through an extruder until the substrate raw materials reach a uniformly plasticized state to obtain a plasticized substrate;
S2. Substrate forming: transporting the plasticized substrate obtained in step S1 from the extruder to a mold runner distributor, and then extruding it through the mold runner distributor to form a substrate structure to obtain a substrate layer;
S3. Pre-bonding: bonding a decorative layer and a wear-resistant layer in sequence on a surface of the substrate layer through a servo film feeding roller and a roller press, and embossing base textures on a lower surface of the substrate layer through the roller press to obtain a semi-finished product; and
S4. Floor forming: embossing surface textures on a surface of the wear-resistant layer of the semi-finished product from step S3 through the roller press to obtain an PET environmental protection flooring.

The PET environmental protection flooring obtained from Comparative Example 1 is directly coated with a UV layer on a surface of the wear-resistant layer of the PET environmental protection flooring through a paint line, and then a back cushion layer is attached to a bottom layer of the substrate layer by using an environmental protection hot melt adhesive, thus to obtain a PET environmental protection flooring product.

The Comparative Examples 2-3 are commercially available PVC floors.

Table 1 shows the component distribution ratio of Embodiments 1-3 and Comparative Example 1.

| product | Components (parts by | | | | Comparative |
|---|---|---|---|---|---|
| structure | weight) | Embodiment 1 | Embodiment 2 | Embodiment 3 | Example 1 |
| wear- | PET | 80 | 85 | 90 | 80 |
| resistant | antioxidant | 10 | 15 | 20 | 10 |
| layer | ultraviolet absorber | 0.5 | 0.5 | 0.5 | 0.5 |
| | colorant | 0.2 | 0.2 | 0.2 | 0.2 |
| decorative | Poly (1,4- | 90 | 90 | 90 | 90 |
| film layer | cyclohexanedimethylene | | | | |
| | terephthalate-co-ethylene | | | | |
| | terephthalate) | | | | |
| | titanium dioxide | 3 | 3 | 3 | 3 |
| | pigment | 6 | 6 | 6 | 6 |
| | solvent | 1 | 1 | 1 | 1 |
| substrate | PET | 70 | 85 | 90 | 70 |
| layer | calcium carbonate | 255 | 275 | 300 | 255 |
| | ethylene-methacrylic acid | 10 | 13 | 15 | 10 |
| | copolymer | | | | |
| | Pentaerythritol stearate | 12 | 10 | 15 | 12 |
| | coloring agent | 0.5 | 0.5 | 0.5 | 0.5 |
| UV layer | acrylate resin | 20 | 25 | 30 | 20 |
| | photoinitiator | 4 | 3 | 5 | 4 |
| | filler | 10 | 8 | 5 | 10 |

Table 2 shows the thickness of each layer of Embodiments 1-3 and Comparative Example 1.

| | Thickness (mm) | | | |
|---|---|---|---|---|
| | | | | Comparative |
| | Embodiment 1 | Embodiment 2 | Embodiment 3 | Example 1 |
| UV layer | 0.02 | 0.02 | 0.02 | 0.02 |
| wear-resistant | 0.2 | 0.5 | 0.7 | 0.5 |
| layer | | | | |
| decorative film | 0.08 | 0.08 | 0.08 | 0.08 |
| layer | | | | |
| substrate layer | 5 | 7 | 9 | 7 |
| back cushion | 0.8 | 1.5 | 3 | 1.5 |

The performances of the above Embodiments 1-3 and Comparative Examples 1-3 are tested, the test conditions are as follows, and the test data are shown in Table 3.

The heating size change rate: placing a sample of the PET environmental protection flooring in an oven and heating it at 80° C. for 6 hours, measuring length changes between two specified marked points in both longitudinal and transverse directions of the sample, then calculating the heating size change rate.

Table 3 shows the test data of the PET environmental protection flooring of Embodiments 1-3 and Comparative Examples 1-3.

| | | | | Comparative | Comparative | |
|---|---|---|---|---|---|---|
| | Embodiment | Embodiment | Embodiment | Example | Example | Comparative |
| Item | 1 | 2 | 3 | 1 | 2 | Example3 |
| density | 1.966 | 2.05 | 2.1 | 2.05 | 2.08 | 2.1 |
| (g/cm3) | | | | | | |
| heating | 0.06 | 0.08 | 0.06 | 0.11 | 0.12 | 0.1 |
| size change | | | | | | |
| rate (%) | | | | | | |

As shown in Table 3, compared with the commercially available PVC floors in Comparative Examples 2-3, the PET environmental protection flooring in Embodiments 1-3 has lower density and heating size change rate; and compared with the Comparative Example 1 without using the low-temperature mixer, the PET environmental protection flooring in Embodiment 1 has lower density and heating size change rate.

The lower density means that the use of the raw materials can be reduced in the production process, and the lower heating size change rate means that the PET flooring has excellent heat resistance and stability, which can be applied to various high temperature environments, such as homes, offices, and commercial spaces, meeting the needs of different environments for floor performances.

The above descriptions are merely illustrative embodiments provided to further explain the technical content of the present invention, so that the reader can understand it more easily, but it does not mean that the embodiments of the present invention is limited to these. Any technical extensions or innovations made based on the present invention shall fall within the protection scope of the present invention, and the protection scope of the present invention shall be subject to the claims.

1. A preparation method of PET environmental protection flooring, comprising the following steps:
S1. Preparing for substrate: according to a preparation ratio, feeding substrate raw materials into a high-speed mixer for heating and stirring, then a low-speed mixer for cooling down and stirring, and then melting the substrate raw material after being cooled down through an extruder until the substrate raw materials reach a uniformly plasticized state to obtain a plasticized substrate;
S2. Substrate forming: transporting the plasticized substrate obtained in step S1 from the extruder to a mold runner distributor, and then extruding it through the mold runner distributor to form a substrate structure to obtain a substrate layer;
S3. Pre-bonding: Pre-bonding: bonding a decorative layer and a wear-resistant layer in sequence on a surface of the substrate layer through a servo film feeding roller and a roller press, and embossing base textures on a lower surface of the substrate layer through the roller press to obtain a semi-finished product; and
S4. Floor forming: embossing surface textures on a surface of the wear-resistant layer of the semi-finished product obtained in step S3 through the roller press to obtain an PET environmental protection flooring.

2. The preparation method of PET environmental protection flooring according to claim 1, wherein a stirring speed of the high-speed mixer in Step S1 is 50-120 kg/min, and a stirring temperature is 115-125° C.; a stirring speed of the low-speed mixer is 200-300 kg/min, and a stirring temperature is 45-55° C.

3. A PET environmental protection flooring, prepared by the preparation method of PET environmental protection flooring according to claim 1, wherein the PET environmental protection flooring comprises a wear-resistant layer, a decorative film layer, and a substrate layer that are arranged in sequence;
the substrate layer includes the following components:
seventy to ninety parts by weight of Polyethylene terephthalate,
two hundred and fifty to three hundred parts by weight of filler,
ten to fifteen parts by weight of toughening agent,
ten to fifteen parts by weight of lubricant, and
zero point five parts by weight of coloring agent.

4. The PET environmental protection flooring according to claim 3, wherein the filler is a calcium carbonate, the toughening agent is an ethylene methacrylic acid copolymer, the lubricant is a Pentaerythrityl tetrastearate, and the colorant is a carbon black or titanium dioxide.

5. The PET environmental protection flooring according to claim 3, wherein
the decorative film layer includes the following components:
ninety parts by weight of Poly (1,4-cyclohexanedimethylene terephthalate-co-ethylene terephthalate),
three parts by weight of titanium dioxide,
six parts by weight of pigment, and
one part by weight of solvent.

6. The PET environmental protection flooring according to claim 3, wherein
the wear-resistant layer includes the following components:
eighty to nighty parts by weight of Polyethylene terephthalate,
ten to fifteen parts by weight of antioxidant,
zero point one to zero point five parts by weight of ultraviolet absorber, and
zero point one to zero point five parts by weight of colorant;
wherein the antioxidant is a bis(2,4-di-tert-butylphenyl) pentaerythritol diphosphite.

7. The PET environmental protection flooring according to claim 3, wherein the PET environmental protection flooring further comprises a UV layer arranged on a side of the wear-resistant layer,
the UV layer includes the following components:
twenty to thirty parts by weight of acrylate resin,
three to five parts by weight of photoinitiator, and
five to ten parts by weight of filler;
wherein the acrylate resin is one or more combinations of polyurethane acrylate, 1,6-hexanediol diacrylate, silicone acrylate resin, and trimethylolpropane triacrylate,
the photoinitiator is a hydroxycyclohexyl phenyl ketone, and
the filler is one or more combinations of ceramic powder, silicon dioxide, and silica micropowder.

8. The PET environmental protection flooring according to claim 3, wherein
the UV layer has a thickness of 0.01-0.03 mm,
the wear-resistant layer has a thickness of 0.07-1.0 mm,
the decorative film layer has a thickness of 0.07-0.12 mm, and
the substrate layer has a thickness of 1-9 mm.

9. The PET environmental protection flooring according to claim 3, wherein the PET environmental protection flooring further comprises a back cushion layer provided on a side of the substrate layer, and the back cushion layer has a thickness of 0.8-3 mm.

10. The PET environmental protection flooring according to claim 3, wherein the PET environmental protection flooring has a density of 1.9-2.1 g/cm³, and the PET environmental protection flooring has a heating size change rate of ≤0.11%.
